(19) United States
(12) Patent Application Publication
(10) Pub. No.: US 2026/0195300 A1
(43) Pub. Date: Jul. 9, 2026

(54) IDENTIFYING STAGNANT JOURNALS IN A DEDUPLICATION STORAGE SYSTEM

(71) Applicant: Hewlett Packard Enterprise Development LP, Spring, TX (US)

(72) Inventors: Callum Murray, Bristol (GB); Aman Sahil, Bristol (GB); Andrew Skinner, Bristol (GB)

(21) Appl. No.: 19/009,496

(22) Filed: Jan. 3, 2025

(51) Int. Cl. G06F 16/174; G06F 16/18

(52) U.S. Cl. CPC G06F 16/1748; G06F 16/1815

(57) ABSTRACT

Example implementations relate to deduplication operations in a storage system. An example includes detecting metadata changes associated with a container index of the deduplication storage system, and recording the metadata changes in multiple journals included in a journal group. The example also includes identifying, in the journal group, a first journal having a filled amount that is less than a fold threshold. The example also includes, determining whether the identified first journal is stagnant based on one or more journal metrics of the identified first journal, and in response to a determination that the identified first journal is stagnant based on the one or more journal metrics, modifying the container index to include each metadata change recorded in the identified first journal.

### BACKGROUND

Data reduction techniques can be applied to reduce the amount of data stored in a storage system. An example data reduction technique includes data deduplication. Data deduplication identifies data units that are duplicative, and seeks to reduce or eliminate the number of instances of duplicative data units that are stored in the storage system.

### BRIEF DESCRIPTION OF THE DRAWINGS

Some implementations are described with respect to the following figures.

FIGS. 1A-1C are illustrations of an example storage system, in accordance with some implementations.

FIG. 2 is an illustration of example data structures, in accordance with some implementations.

FIGS. 3A-3B are illustrations of example data structures, in accordance with some implementations.

FIG. 4 is an illustration of an example process, in accordance with some implementations.

FIGS. 5A-5B are illustration of example operations, in accordance with some implementations.

FIG. 6 is an illustration of an example process, in accordance with some implementations.

FIG. 7 is a schematic diagram of an example computing device, in accordance with some implementations.

FIG. 8 is an illustration of an example process, in accordance with some implementations.

FIG. 9 is a diagram of an example machine-readable medium storing instructions in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a storage system may receive a data stream from an external data source or system, and may store or “backup” a copy of the data stream. For example, the data stream may be generated by a backup system or program during a backup of a collection of data. The data stream may include discrete data units (or “chunks”) that are generated by the data source. Further, in some examples, the storage system may backup at least a portion of the data stream in deduplicated form, to thereby reduce the amount of storage space occupied by storage of the data stream. The storage system may create a “backup item” to represent a data stream in a deduplicated form. The storage system may perform a deduplication process including determining “fingerprints” (described below) for the incoming data units. Further, the storage system may compare the fingerprints of incoming data units to fingerprints of stored data units, and may thereby determine which incoming data units are duplicates of previously stored data units (e.g., when the comparison indicates matching fingerprints). In the case of data units that are duplicates, the storage system may store references to previously stored data units instead of storing the duplicate incoming data units.

As used herein, the term “fingerprint” refers to a value derived by applying a function on the content of the data unit (where the “content” can include the entirety or a subset of the content of the data unit). An example of a function that can be applied includes a hash function that produces a hash value based on the content of an incoming data unit. Examples of hash functions include cryptographic hash functions such as the Secure Hash Algorithm 2 (SHA-2) hash functions, e.g., SHA-224, SHA-256, SHA-384, etc. In other examples, other types of hash functions or other types of fingerprint functions may be employed.

A “storage system” can include a storage device or an array of storage devices. A storage system may also include storage controller(s) that manage(s) access of the storage device(s). A “data unit” can refer to any portion of data that can be separately identified in the storage system. In some cases, a data unit can refer to a chunk, a collection of chunks, or any other portion of data. In some examples, a storage system may store data units in persistent storage. Persistent storage can be implemented using one or more of persistent (e.g., nonvolatile) storage device(s), such as disk-based storage device(s) (e.g., hard disk drive(s) (HDDs)), solid state device(s) (SSDs) such as flash storage device(s), or the like, or a combination thereof.

A “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

In some examples, a storage system may use metadata structures for processing inbound data streams (e.g., backup items). For example, such metadata structures may include data recipes (also referred to herein as “manifests”) that specify the order in which particular data units are received for each backup item. Further, such metadata structures may include item metadata to represent each received backup item (e.g., a data stream) in a deduplicated form. The item metadata may include identifiers for a set of manifests, and may indicate the sequential order of the set of manifests. The processing of each backup item may be referred to herein as a “backup process.” Subsequently, in response to a read request, the storage system may use the item metadata and the set of manifests to determine the received order of data units, and may thereby recreate the original data stream of the backup item. Accordingly, the set of manifests may be a representation of the original backup item.

In some examples, the manifests may include a sequence of records, with each record representing a particular set of data unit(s). The records of the manifest may include one or more fields that identify container indexes. The container indexes may be metadata structures that index (e.g., include storage information for) the data units. For example, a container index may include multiple entries, and each entry may include one or more metadata fields that specify location information (e.g., data containers, offsets, etc.) for the stored data units, compression and/or encryption characteristics of the stored data units, and so forth. Further, the container index may include reference counts that indicate the number of manifests that reference each data unit.

In some examples, upon receiving a data unit (e.g., in a data stream), it may be matched against one or more container indexes to determine whether an identical data unit is already stored in a container of the storage system. For example, the storage system may compare the fingerprint of the received data unit against the fingerprints in one or more container indexes. As used herein, the term “matching operation” may refer to an operation to compare fingerprints of a collection of multiple data units (e.g., from a particular backup data stream) against fingerprints stored in one or more container indexes. If no matching fingerprints are found in the searched container index(es), the received data unit may be added to a data container, and a metadata entry for the received data unit may be added to a container index corresponding to that container. However, if a matching fingerprint is found in a searched container index, it may be determined that a data unit identical to the received data unit is already stored in an existing data container. In response to this determination, the reference count of the corresponding entry may be incremented, and the received data unit is not stored in a data container (as it is already present in one of the data containers), thereby avoiding storing a duplicate data unit in the storage system.

In some examples, the storage system may use journals associated with the container indexes. When events occur that would result in changes to the metadata stored in a container index, those changes may be recorded in a journal associated with that container index. Subsequently, when a requirement exists to write the container index to persistent storage, the journal may be written to the persistent storage instead of the container index. Further, because the journal records only the changes that correspond to the container index (rather than all data in the container index), writing the journal to persistent storage will consume relatively less processing time and bandwidth than would be required if the container index was being written to persistent storage. In some examples, a journal group may be formed from multiple journals. The journal group may be written to the persistent storage as a whole in order to reduce the total number of write operations (i.e., in comparison to performing a different write operation for each journal).

In some examples, the size of the journals may be controlled by imposing a size limit (referred to herein as a “fold threshold”) on each journal. When the amount of data stored in a journal reaches the fold threshold, that journal data is transferred or “folded” into the associated container index, thereby clearing the journal to receive new change data. However, in some examples, a journal group may include one or more journals that remain filled to levels below the fold threshold for an extended period of time (such journals referred to herein as “stagnant journals”). In such examples, the stagnant journals are transferred each time that the journal group is transferred to or from the persistent storage, but the transferred stagnant journals are not updated to include any new change information. Accordingly, the transfer of the stagnant journals in the journal group may consume a significant amount of bandwidth without providing any useful purpose, and may thereby reduce the performance of the storage system.

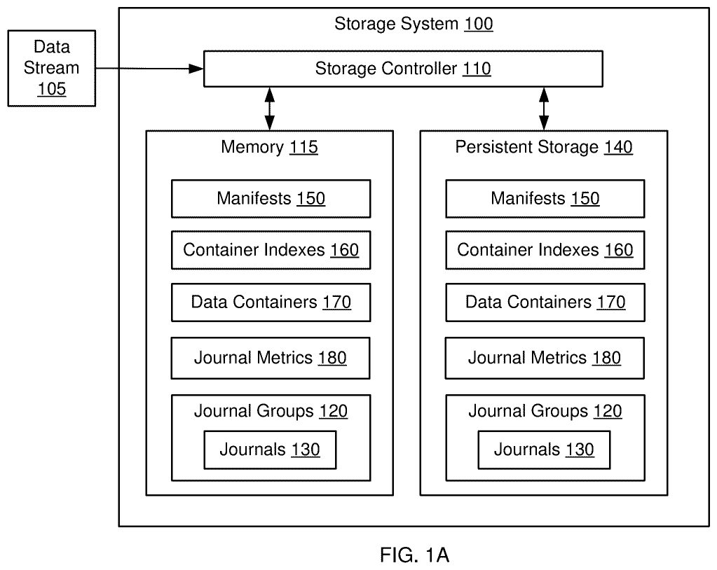

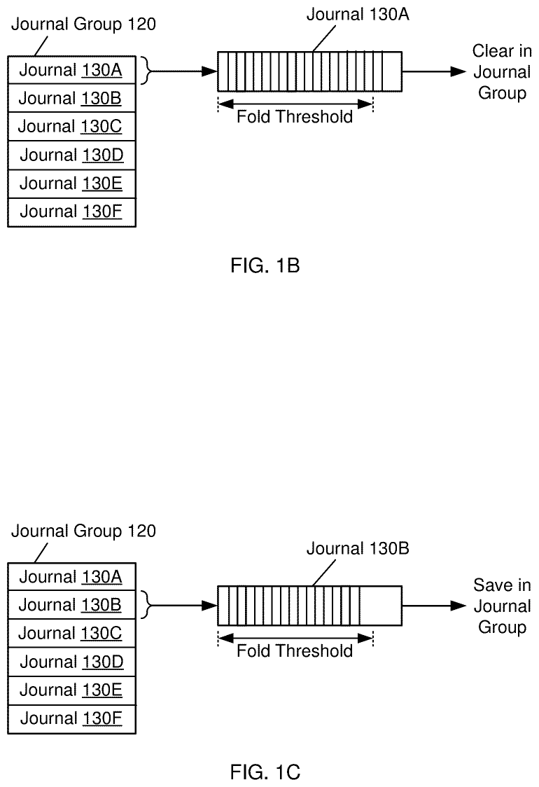

In accordance with some implementations of the present disclosure, a controller of a deduplication storage system may generate journal metrics to reflect characteristics of each journal over time. The journal metrics may include a fill rate metric that indicates the increase in the filled amount of a journal over time. Further, the journal metrics may include a bandwidth metric that indicates the cumulative bandwidth usage of the journal over time. In some implementations, the controller may analyze the journal metrics to identify any stagnant journals, and may then clear the stagnant journals by folding their contents into one or more container indexes. In this manner, the number of stagnant journals may be reduced, thereby reducing or eliminating the wasted bandwidth associated with transferring the stagnant journals to and from storage. Accordingly, some implementations may improve the performance of the storage system. The disclosed technique reducing stagnant journals is discussed further below with reference to FIGS. 1A-9.

### FIGS. 1A-1C—Example Storage System

FIG. 1A shows an example of a storage system 100 that includes a storage controller 110, memory 115, and persistent storage 140, in accordance with some implementations. The persistent storage 140 may include one or more non-transitory storage media such as hard disk drives (HDDs), solid state drives (SSDs), optical disks, and so forth, or a combination thereof. The memory 115 may be implemented in semiconductor memory such as random access memory (RAM). In some examples, the storage controller 110 may be implemented via hardware (e.g., electronic circuitry) or a combination of hardware and programming (e.g., comprising at least one processor and instructions executable by the at least one processor and stored on at least one machine-readable storage medium).

As shown in FIG. 1A, the memory 115 and the persistent storage 140 may store various data structures including at least manifests 150, container indexes 160, data containers 170, journal metrics 180, and journal groups 120. In some examples, copies of the manifests 150, container indexes 160, data containers 170, journal metrics 180, and journal groups 120 may be transferred between the memory 115 and the persistent storage 140 (e.g., via read and write input/output (I/O) operations).

In some implementations, the storage system 100 may perform a data ingest operation to deduplicate received data. For example, the storage controller 110 may receive an inbound data stream 105 including multiple data units, and may store at least one copy of each data unit in a data container 170 (e.g., by appending the data units to the end of the data container 170). Further, the data stream 105 may be divided into different localities (e.g., portions or segments) in the stream. In some examples, each instance of a received data stream 105 may represent a unique backup of a collection of data. Further, in some examples, an inbound stream may be deduplicated and stored as a backup item.

In some implementations, the storage controller 110 may generate a fingerprint for each received data unit. For example, the fingerprint may include a full or partial hash value based on the data unit. To determine whether an incoming data unit is a duplicate of a stored data unit, the storage controller 110 may compare the fingerprint generated for the incoming data unit to the fingerprints in at least one container index 160. The process of comparing fingerprints of one or more received data units against fingerprints of one or more container indexes 160 may be referred to herein as a “matching operation.” If a match is identified in a matching operation, the storage controller 110 may determine that a duplicate of the incoming data unit is already stored by the storage system 100. The storage controller 110 may then store references to the previous data unit, instead of storing the duplicate incoming data unit. Otherwise, if no match is identified in the matching operation, the storage controller 110 may determine that the incoming data unit is a new data unit (i.e., is not already stored by the storage system 100). The storage controller 110 may then store a copy of the new data unit in a data container 170, and may index the new data unit in a container index 160.

In some implementations, the manifests 150 may include a pointer or other information indicating the container index 160 that indexes each data unit. In some implementations, the container index 160 may include a fingerprint (e.g., a hash) of a stored data unit for use in a matching process of a deduplication process. Further, the container index 160 may indicate the location in which the data unit is stored. For example, the container index 160 may include information specifying that the data unit is stored at a particular offset in an entity, and that the entity is stored at a particular offset in a data container 170. The container index 160 may also include reference counts that indicate the number of manifests 150 that reference each data unit. In some implementations, a container index 160 may record metadata for data units included in the locality portion (in data stream 105) that is allocated or associated to that container index 160.

In some implementations, prior to attempting to perform matching operations for received data units, the storage controller 110 may identify a particular container index 160 (referred to herein as the “candidate” container index) to use in matching operations for received data unit(s). In some examples, the candidate container index may be identified using a data structure (referred to herein as a “sparse index”) that maps a relatively small subset of fingerprints (referred to herein as “hook points”) to corresponding container indexes 160. For example, the hook points of incoming data units may be compared to the hook points in the sparse index, and the container index 160 with the highest number of matching hook points may be identified as the candidate container index. Alternatively, in some implementations, the sparse index may be used to identify a “candidate list” including multiple container indexes 160 (e.g., five container indexes 160) that have the highest numbers of matching hook points. In such implementations, the candidate list may be used in matching operations for received data unit(s). In some implementations, the sparse index may contain entries for a subset of fingerprints defined by a sparse fingerprint condition. As used herein, the term “hook points” refers to the subset of fingerprints that meet the sparse fingerprint condition. In some examples, the sparse fingerprint condition may be a condition that is met by a relatively small number of all of the possible fingerprints. For example, the sparse fingerprint condition may be whether a given fingerprint (e.g., in a binary representation) includes a particular bit pattern at a particular offset.

In some implementations, the storage controller 110 may receive a read request to access the stored data, and in response may access metadata (e.g., one or more manifests 150) to determine the sequence of data units that made up the original data. The storage controller 110 may then use pointer data included in a manifest 150 to identify the container indexes 160 that index the data units. Further, the storage controller 110 may use information included in the identified container indexes 160 (and information included in the manifest 150) to determine the locations that store the data units (e.g., data container 170, entity, offsets, etc.), and may then read the data units from the determined locations.

In some implementations, each journal group 120 may be a data structure grouping multiple journals 130. Each journal 130 may be a data structure associated with a corresponding container index 160. Further, each journal 130 may include information indicating changes to the data stored in the container index 160 associated with that journal 130. For example, when a copy of the container index 160 present in memory 115 is modified to reflect a change to the metadata, that change may also be recorded as an entry in the associated journal 130. Subsequently, when a requirement exists to write the container index 160 to persistent storage 140, the associated journal 130 may be written to the persistent storage 140 instead of the container index 160. Further, because the journal 130 records only the changes that correspond to the container index 160 (rather than all data in the container index 160), writing the journal 130 to persistent storage 140 will consume relatively less processing time and bandwidth than would be required if the container index 160 was being written to persistent storage. In some implementations, multiple journals 130 are written to persistent storage 140 as part of a journal group 120. The journal group 120 may be written to the persistent storage 140 as a whole, thereby reducing the total number of write operations (i.e., in comparison to performing a different write operation for each journal 130).

In some implementations, the storage controller 110 may determine whether the filled amount of a journal 130 exceeds a fold threshold. As used herein, the “filled amount” of the journal 130 refers to the level or proportion of the journal 130 that is occupied by data that records metadata changes. In some implementations, the fold threshold may be a configuration setting or parameter specifying the filled amount of a journal 130 that triggers or causes a fold of the data in the journal 130. Accordingly, upon determining that the filled amount of a journal 130 exceeds the fold threshold, the storage controller 110 may fold the data in that journal 130 into the associated container index 160, thereby clearing the journal to receive new change data. For example, as shown in FIG. 1B, a journal group 120 includes multiple journals 130A-130F. The storage controller 110 determines that the filled amount of the first journal 130A exceeds the fold threshold, and in response clears the first journal 130A. In this manner, the data that is cleared from the first journal 130A is no longer transferred in subsequent transfers of the journal group 120 to and from persistent storage. In some implementations, the storage controller 110 clears the first journal 130A by folding the journal data in the journal 130A into a container index 160. As used herein, “folding” journal data may refer to accessing the metadata changes recorded in a journal 130 in chronological order (e.g., in order of occurrence), sequentially performing the changes in a container index 160, and deleting the metadata changes from the journal 130.

Referring now to FIG. 1C, the storage controller 110 determines that the filled amount of a second journal 130B remains below the fold threshold, and thus leaves the second journal 130B saved in the journal group 120. Accordingly, when the journal group 120 is subsequently transferred to and from persistent storage, the second journal 130B is also transferred. Further, if the second journal 130B remains below the fold threshold for an extended period of time, the second journal 130 may be referred to as a stagnant journal. If so, the transfers of the second journal 130B may consume a significant amount bandwidth without providing any useful purpose, and may thereby reduce the performance of the storage system 100.

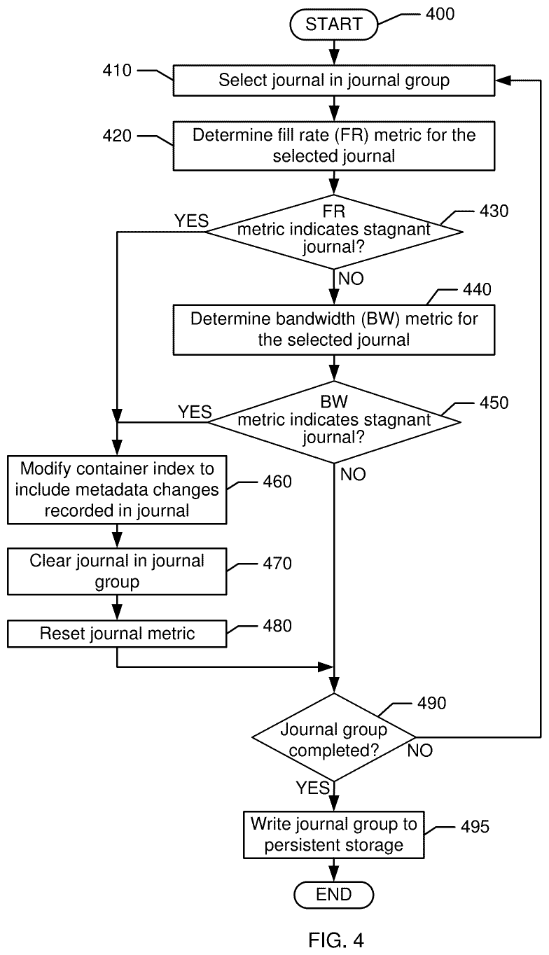

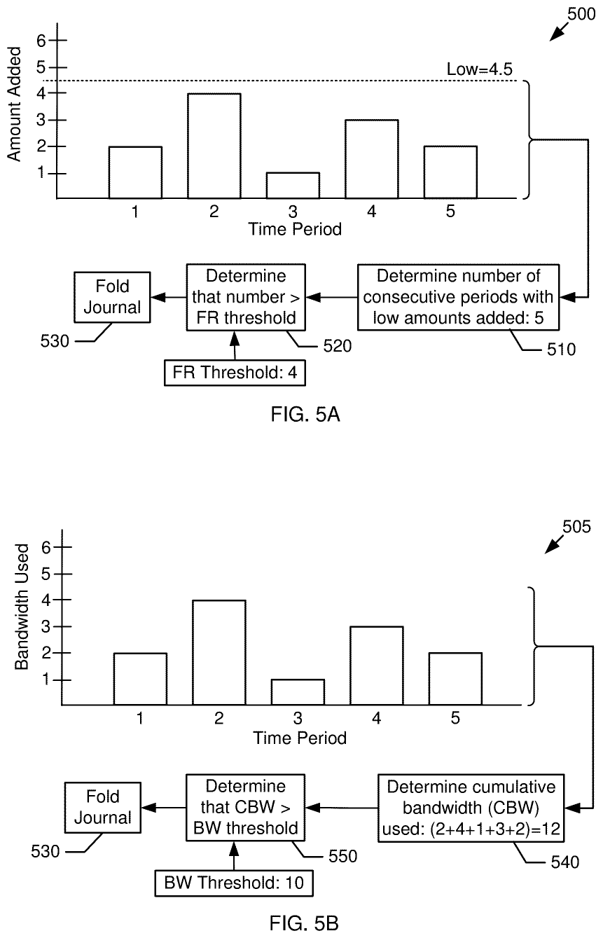

Referring again to FIG. 1A, in some implementations, the storage controller 110 may generate the journal metrics 180 to record information regarding each journal 130 over time. Some example implementations of the journal metrics 180 are discussed further below with reference to FIGS. 5A-5B. Further, the storage controller 110 may analyze the journal metrics 180 to identify stagnant journals 130, and may then clear the stagnant journals 130 by folding their contents into one or more container indexes 160. In this manner, the number of stagnant journals 130 may be reduced, thereby reducing or eliminating the wasted bandwidth associated with transferring the stagnant journals to and from persistent storage 140. An example process for clearing stagnant journals 130 is discussed further below with reference to FIG. 4.

Note that, while FIG. 1A illustrates the journal metrics 180 as a stand-alone data structure, implementations are not limited in this regard. For example, the journal metrics 180 for the journals 130 in a particular journal group 120 may be stored as data fields included in that journal group 120. In another example, the journal metrics 180 for a particular journal 130 may be stored in that journal 130. Further, in other implementations, the journal metrics 180 may be stored in any other data structure of the storage system 100.

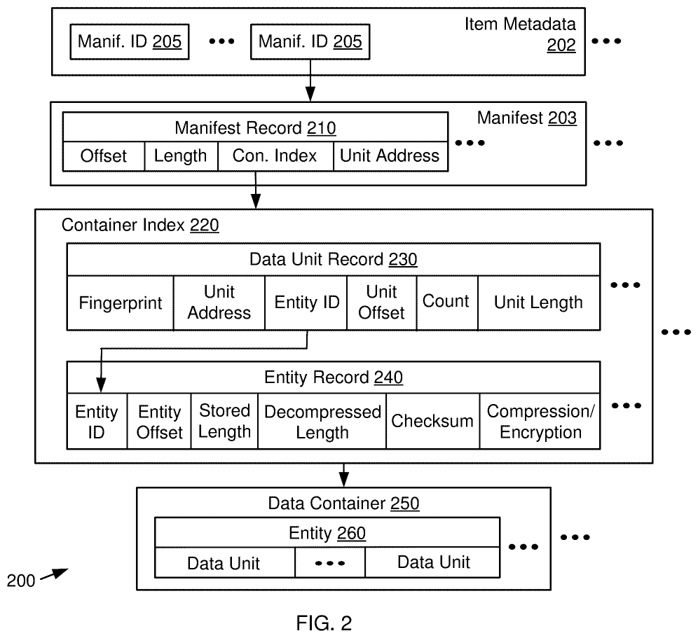

### FIG. 2—Example Data Structures

FIG. 2 shows example data structures 200 used in deduplication, in accordance with some implementations. As shown, the data structures 200 may include item metadata 202, a manifest 203, a container index 220, and a data container 250. In some examples, the manifest 203, the container index 220, and the data container 250 may correspond generally to example implementations of a manifest 150, a container index 160, and a data container 170 (shown in FIG. 1A), respectively. In some examples, the data structures 200 may be generated and/or managed by the storage controller 110 (shown in FIG. 1).

In some implementations, the item metadata 202 may include multiple manifests identifiers 205. Each manifests identifier 205 may identify a different manifest 203. In some implementations, the manifests identifiers 205 may be arranged in a stream order (i.e., based on the order of receipt of the data units represented by the identified manifests 203).

Although one of each is shown for simplicity of illustration in FIG. 2, data structures 200 may include a plurality of instances of item metadata 202, each including or pointing to one or more manifests 203. In such examples, data structures 200 may include a plurality of manifests 203. The manifests 203 may reference a plurality of container indexes 220, each corresponding to one of a plurality of data containers 250. Each container index 220 may comprise one or a plurality of data unit records 230, and one or a plurality of entity records 240.

As shown in FIG. 2, in some examples, each manifest 203 may include one or more manifest records 210. Each manifest record 210 may include various fields, such as offset, length, container index, and unit address. In some implementations, each container index 220 may include any number of data unit record(s) 230 and entity record(s) 240. Each data unit record 230 may include various fields, such as a fingerprint (e.g., a hash of the data unit), a unit address, an entity identifier, a unit offset (i.e., an offset of the data unit within the entity), a reference count value, a unit length, and an arrival time. The reference count value may indicate the number of manifest records 210 that reference the data unit record 230. In some implementations, the arrival time (e.g., stored in the data unit record 230) may record the data and time that the data unit is received by the storage system. In other implementations, the arrival time may indicate the data and time that the data unit record 230 was created to record information regarding the received data unit.

In some implementations, each entity record 240 may include various fields, such as an entity identifier, an entity offset (i.e., an offset of the entity within the container), a stored length (i.e., a length of the data unit within the entity), a decompressed length, a checksum value, and compression/encryption information (e.g., type of compression, type of encryption, and so forth). In some implementations, each container 250 may include any number of entities 260, and each entity 260 may include any number of stored data units.

In one or more implementations, the data structures 200 may be used to retrieve stored deduplicated data. For example, a read request may specify an offset and length of data in a given file. These request parameters may be matched to the offset and length fields of a particular manifest record 210. The container index and unit address of the particular manifest record 210 may then be matched to a particular data unit record 230 included in a container index 220. Further, the entity identifier of the particular data unit record 230 may be matched to the entity identifier of a particular entity record 240. Furthermore, one or more other fields of the particular entity record 240 (e.g., the entity offset, the stored length, checksum, etc.) may be used to identify the container 250 and entity 260, and the data unit may then be read from the identified container 250 and entity 260.

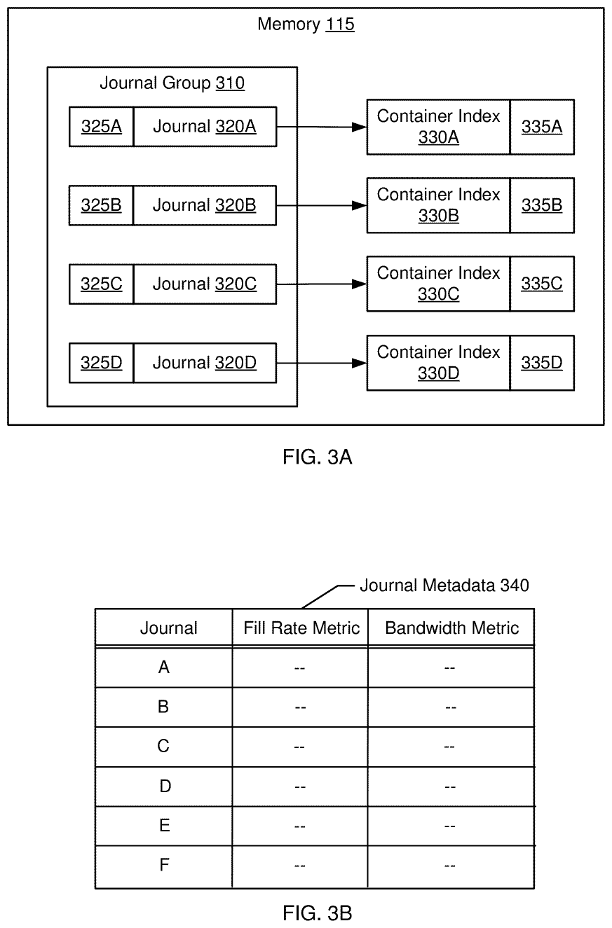

### FIGS. 3A-3B—Example Data Structures

FIG. 3A shows an illustration of the memory 115 including a journal group 310 and multiple container indexes 330A-330D (also referred to herein as “container indexes 330”). As shown, the journal group 310 includes multiple journals 320A-320D (also referred to herein as “journals A-D” or “journals 320”). The journal group 310, journals 320, and container indexes 330 may correspond generally to example implementations of the journal group 120, journals 130, and container indexes 160 (shown in FIG. 1A), respectively.

As shown in FIG. 3A, each of the journals 320A-320D may be associated with a corresponding one of the container indexes 330A-330. Further, each of the journals 320A-320D may record changes to the metadata stored in the corresponding one of the container indexes 330A-330D. In some implementations, each of the journals 320A-320D may include or be associated with a corresponding one of version numbers 325A-325D (also referred to herein as “version numbers 325”). Each one of the container indexes 330A-330D may include or be associated with a corresponding one of version numbers 335A-335D (also referred to herein as “version numbers 335”).

In some implementations, the version number 325 may be compared to the version number 335 to determine whether the journal 320 or the associated container index 330 reflects the latest version of metadata. For example, if the version number 325 is greater than the version number 335, it may be determined that the change data included in the journal 320 reflects a state of metadata that is more recent than the metadata stored in the container index 330. If so, the container index 330 may be updated to include the changes recorded in the journal 320. However, if the version number 325 is smaller than the version number 335, it may be determined that the change data included in the journal 320 reflects a state of metadata that is older than the metadata stored in the container index 330. In this situation, the journal 320 may be cleared without updating the container index 330. In some implementations, the comparison of the version number 325 to the version number 335 may be performed in response to loading the journal 320 or the associated container index 330 from persistent storage into memory (e.g., from persistent storage 140 into memory 115, as shown in FIG. 1).

In one or more implementations, the number of journals 320 included in a journal group 310 may be specified in a stored parameter (e.g., a user setting, a configuration variable, and so forth). In some examples, this parameter may be adjusted or tuned to modify the performance characteristics of input/output (I/O) operations in a storage system. For example, this parameter may be increased to attempt to obtain relatively less frequent write I/O operations of relatively larger size. In another example, this parameter may be decreased to attempt to obtain relatively more frequent write I/O operations of relatively smaller size.

Referring now to FIG. 3B, shown is an example of journal metadata 340. The journal metadata 340 may correspond generally to an example implementation of the journal metrics 180 (shown in FIG. 1A). Further, the journal metadata 340 may be a data structure including multiple entries (e.g., rows), with each entry identifying a different journal (e.g., journals A-F). Further, each entry may include fields or values to record different metric values for the entry identified by that entry. For example, as shown in FIG. 3B, each entry may include a fill rate metric that indicates the increase in filled amount of a journal over time. Further, each entry may include a bandwidth metric that indicates the cumulative bandwidth usage of a journal over time. Some example implementations of a fill rate metric and a bandwidth metric are discussed further below with reference to FIGS. 5A-5B.

In some implementations, the journal metadata 340 may be updated continually (or periodically) to reflect any change in the journal metrics over time. For example, a controller may detect the write (e.g., transfer to persistent storage) of a particular journal group, and in response may recalculate the metrics in the entries (e.g., in journal metadata 340) that correspond to the journals included in that particular journal group. Further, in some implementations, the controller may use the journal metadata 340 to identify any stagnant journals in a journal group, and may then clear the identified stagnant journals. An example process for clearing stagnant journals is described below with reference to FIG. 4.

Note that, while FIG. 3B illustrates one example of journal metadata 340, implementations are not limited in this regard. For example, the journal metadata 340 may only include a fill rate metric, or alternatively may only include the bandwidth metric. Further, in other implementations, the journal metadata 340 may include additional metrics, different metrics, or any other combination or variation.

### FIG. 4—Example Process for Clearing Stagnant Journals

FIG. 4 shows an example process 400 for clearing stagnant journals, in accordance with some implementations. For the sake of illustration, details of the process 400 may be described below with reference to FIGS. 1-3B, which show examples in accordance with some implementations. However, other implementations are also possible. In some examples, the process 400 may be performed using the storage controller 110 (shown in FIG. 1A). The process 400 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 410 may include selecting a journal in a journal group. Block 420 may include determining a fill rate (FR) metric for the selected journal. Decision block 430 may include determining whether the fill rate metric indicates that the selected journal is stagnant For example, referring to FIGS. 3A-3B, a controller (e.g., storage controller 110 shown in FIG. 1A) selects a first journal 320A included in a journal group 310. In this example, the journal 320A has a filled amount that is less than a fold threshold, and therefore the contents of the journal 320A have not been folded into the container index 330A. The controller reads the fill rate metric stored in the journal “A” entry (i.e., the entry associated with journal 320A) in the journal metadata 340, and then compares the fill rate metric with a fill rate threshold. In some implementations, the fill rate metric may be a numeric value that indicates the increase in filled amount of a journal over time. Further, the fill rate threshold may be a configuration setting or parameter specifying the filled amount of a journal, across a specified period of time, below which the journal is considered to be stagnant. As such, if the fill rate metric is larger than the fill rate threshold, the journal is not determined to be stagnant. Alternatively, if the fill rate metric is less than the fill rate threshold, the journal is determined to be stagnant. An example operation using a fill rate metric is described below with reference to FIG. 5A.

Referring again to FIG. 4, if it is determined at decision block 430 that the fill rate metric does not indicate that the selected journal is stagnant (“NO”), the process 400 may continue at block 440, including determining a bandwidth (BW) metric for the selected journal. Decision block 450 may include determining whether the bandwidth metric indicates that the selected journal is stagnant.

For example, referring to FIGS. 3A-3B, the controller reads the bandwidth metric stored in the journal “A” entry, and then compares the bandwidth metric with a bandwidth threshold. In some implementations, the bandwidth metric may be a numeric value that indicates the cumulative bandwidth usage of a journal over time. Further, the bandwidth threshold may be a may be a configuration setting or parameter specifying the cumulative bandwidth usage, across a specified period of time, above which the journal is considered to be stagnant. As such, if the bandwidth metric is less than the bandwidth threshold, the journal is not determined to be stagnant. Alternatively, if the bandwidth metric is greater than the bandwidth threshold, the journal is determined to be stagnant. An example operation using a bandwidth metric is described below with reference to FIG. 5B.

Referring again to FIG. 4, if it is determined at decision block 430 that the fill rate metric indicates that the selected journal is stagnant (“YES”), or if it is determined at decision 450 that the bandwidth metric indicates that the selected journal is stagnant (“YES”), the process 400 may continue at block 460, including modifying a container index to include the metadata changes recorded in the journal. Block 470 may include clearing the journal. Block 480 may include resetting the journal metric for the cleared journal.

For example, referring to FIGS. 3A-3B, the controller determines that the journal “A” bandwidth metric is greater than the bandwidth threshold (i.e., indicating that the selected journal is stagnant), and in response folds the contents of journal “A” into an associated container index, clears the journal “A,” and then resets the journal “A” bandwidth metric. In another example, the controller determines that the journal “B” fill rate metric is greater than the fill rate threshold, and in response folds the contents of journal “B” into an associated container index, clears the journal “B,” and then resets the journal “B” metrics in the journal metadata 340 (e.g., by deleting the recorded value(s) of the fill rate metric and/or the bandwidth metric in the journal metadata 340).

Referring again to FIG. 4, after block 480, or if it is determined at decision block 450 that the bandwidth metric does not indicate that the selected journal is stagnant (“NO”), the process 400 may continue at decision block 490, including determining whether the journal group has been completed (i.e., all journal in the journal group have been processed). Upon a negative determination (“NO”), the process 400 may return to block 410 (i.e., to select another journal in the journal group). Otherwise, if it is determined at decision block 490 that the journal group has been completed (“YES”), the process 400 may continue at block 495, including writing the journal group to a persistent storage. After block 495, the process 400 may be completed.

For example, referring to FIG. 1A, the storage controller 110 determines that all journals 130 included in particular journal group 120 have been processed (e.g., in blocks 410-490 shown in FIG. 4), and in response writes the particular journal group 120 as a whole from the memory 115 to the persistent storage 140. Further, in some examples, the storage controller 110 may also write the updated journal metrics 180 (and any updated container indexes 160) from the memory 115 to the persistent storage 140.

In some implementations, the process 400 may be performed along with other data operations of the storage system 100. For example, the process 400 may be performed in response to loading a container index 160 into the memory 115 (e.g., to perform a matching operation for new data units received in the data stream 105). However, in other implementations, the process 400 may be performed as a stand-alone process for clearing stagnant journals (e.g., in response to a user command, in response to a timer expiration, in response to a predefined schedule, and so forth). Other implementations are possible.

### FIGS. 5A-5B—Example Operations Using Journal Metrics

FIG. 5A illustrates an example operation 500 using a fill rate (FR) metric, in accordance with some implementations. The operation 500 may include tracking or determining the amounts of data added to a particular journal (“Amount Added”) over multiple periods in time (“Time Periods”). For example, each time period may be defined by a different save (i.e., a write to persistent storage) of the journal group that includes the particular journal. In another example, each time period may be defined as specific amount of elapsed time (e.g., ten seconds, one minute, and so forth).

In some implementations, the operation 500 may include a determination 510 of a number of consecutive time periods in which the amount added to the particular journal is below a low threshold (also referred to herein as the “consecutive periods with low amounts added”). In the example shown in FIG. 5A, the low threshold is equal to 4.5, and the FR number is equal to 5. The low threshold may be a configuration setting or parameter of a storage system (e.g., storage system 100 shown in FIG. 1A).

The operation 500 may include a determination 520 that the number of consecutive periods with low amounts added (i.e., 5) is greater than a FR threshold (i.e., 4), thereby indicating that the particular journal is stagnant. The operation 500 may also include, in response to the determination 520, performing a fold 530 of the particular journal. In some implementations, the fold 530 may include copying the folds the contents of the particular journal into an associated container index, clearing the particular journal, and resetting the fill rate metric for the particular journal.

Referring now to FIG. 5B, shown is an example operation 505 using a bandwidth (BW) metric, in accordance with some implementations. The operation 505 may include tracking or determining the amounts of bandwidth used to transfer a particular journal (“Bandwidth Used”) over multiple periods in time (“Time Periods”). Further, the operation 505 may include a determination 540 of the cumulative bandwidth (CBW) used over a specified number of time periods. In the example shown in FIG. 5B, the specified number of time periods is equal to 5, and the CBW used is equal to 12. The specified number of time periods may be a configuration setting or parameter of a storage system (e.g., storage system 100 shown in FIG. 1A).

The operation 505 may include a determination 550 that the CBW used (i.e., 12) is greater than a BW threshold (i.e., 10), thereby indicating that the particular journal is stagnant. The operation 505 may also include, in response to the determination 550, performing a fold 530 of the particular journal.

Note that, while FIGS. 5A-5B illustrate some example operations using journal metrics, implementations are not limited by these examples. For example, regarding FIG. 5A, the determination 510 may include calculating the proportion of time periods (e.g., eight non-consecutive periods included in the ten most recent periods) in which the amount added to the particular journal is below the low threshold. In another example, it is contemplated that the fill rate metric may be calculated as the moving average of amounts of data added to a particular journal over a specified number of time periods. In yet another example, regarding FIG. 5B, it is contemplated that the bandwidth (BW) threshold may be dynamically calculated or adjusted to cause a particular proportion or percentage of journals (e.g., top ten percent of journals in bandwidth usage) to be cleared or folded based on the bandwidth metric. Further, regarding determination 520, it is contemplated that the journal may also be determined to be stagnant if the number of consecutive periods with low amounts added is equal to the FR threshold. Furthermore, regarding determination 550, it is contemplated that the journal may also be determined to be stagnant if the CBW used is equal to the BW threshold. Other variations are possible.

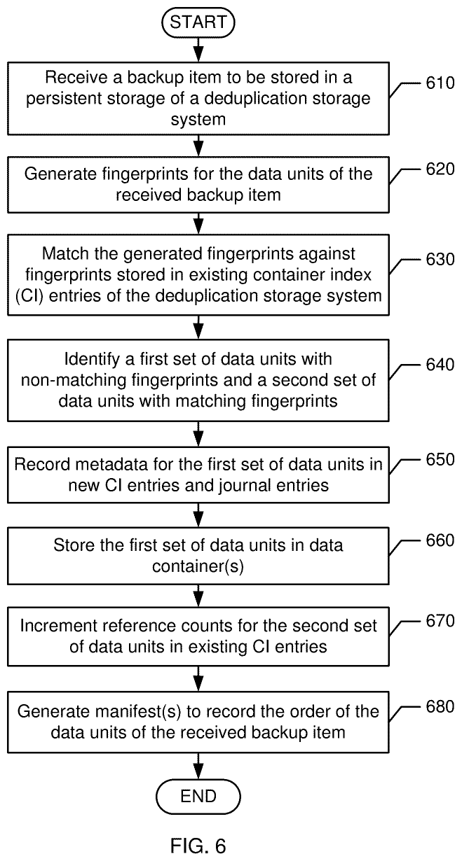

### FIG. 6—Example Process for Generating Metadata

FIG. 6 shows an example process 600 for generating metadata, in accordance with some implementations. For the sake of illustration, details of the process 600 may be described below with reference to FIG. 1A, which shows an example in accordance with some implementations. However, other implementations are also possible. In some examples, the process 600 may be performed using the storage controller 110 (shown in FIG. 1A). The process 600 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 610 may include receiving a backup item to be stored in a persistent storage of a deduplication storage system. Block 620 may include generating fingerprints for the data units of the received backup item. Block 630 may include matching the generated fingerprints against fingerprints stored in existing container index (CI) entries of the deduplication storage system. Block 640 may include identifying a first set of data units with non-matching fingerprints and a second set of data units with matching fingerprints.

Block 650 may include recording metadata for the first set of data units in new CI entries and journal entries. Block 660 may include storing the first set of data units in one or more data containers. Block 670 may include incrementing reference counts for the second set of data units in existing CI entries. Block 680 may include generating one or more manifests to record the order of the data units of the received backup item.

For example, referring to FIG. 1A, the storage controller 110 receives a backup item (e.g., data stream 105) to be stored in the deduplication storage system 100, and generates fingerprints for the data units in the received backup item. The storage controller 110 compares the generated fingerprints to the fingerprints included in container indexes 160. If a match is identified for a data unit, then the storage controller 110 determines that a duplicate of the data unit is already stored by the storage system 100. In response to this determination, the storage controller 110 stores a reference to the previous data unit (e.g., in a manifest 150) in deduplicated form. Otherwise, if a match is not identified for a data unit, then the storage controller 110 stores the data unit in a data container 170, adds a metadata entry for the data unit to a container index 160 corresponding to that data container 170, and adds a metadata entry to the journal 130 associated with that container index 160. In some implementations, the storage controller 110 records the order in which data units are received in one or more manifests 150.

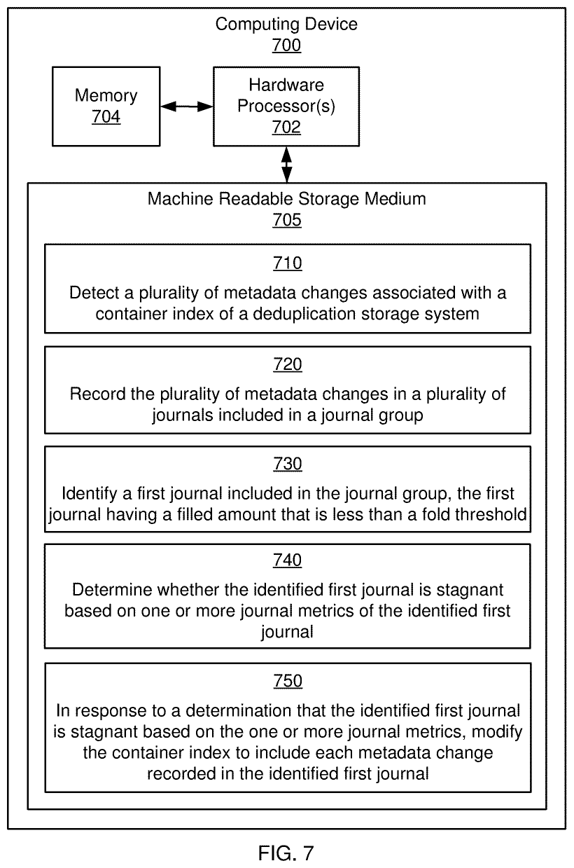

### FIG. 7—Example Computing Device

FIG. 7 shows a schematic diagram of an example computing device 700. In some examples, the computing device 700 may correspond generally to some or all of the storage system 100 (shown in FIG. 1A). As shown, the computing device 700 may include a hardware processor 702, a memory 704, and machine-readable storage 705 including instructions 710-750. The machine-readable storage 705 may be a non-transitory medium. The instructions 710-750 may be executed by the hardware processor 702, or by a processing engine included in hardware processor 702.

Instruction 710 may be executed to detect a plurality of metadata changes associated with a container index of a deduplication storage system. Instruction 720 may be executed to record the plurality of metadata changes in a plurality of journals included in a journal group. For example, referring to FIGS. 1A and 3A, the storage controller 110 may detect changes to the metadata stored in the container indexes 330A-330D. For example, such changes may include an increase to a reference count stored in the container index 330D (e.g., in the count field(s) in the data unit record 230 shown in FIG. 2). The storage controller 110 may record the detected metadata changes in the corresponding journal 320D in the journal group 310. Further, the storage controller 110 may also modify the container index 330D to include the detected metadata changes.

Referring again to FIG. 7, instruction 730 may be executed to identify a first journal included in the journal group, the first journal having a filled amount that is less than a fold threshold. Instruction 740 may be executed to determine whether the identified first journal is stagnant based on one or more journal metrics of the identified first journal. Instruction 750 may be executed to, in response to a determination that the identified first journal is stagnant based on the one or more journal metrics, modify the container index to include each metadata change recorded in the identified first journal.

For example, referring to FIGS. 1A and 3A-3B, the storage controller 110 selects a first journal 320A included in a journal group 310. In this example, the journal 320A has a filled amount that is less than a fold threshold, and therefore the contents of the journal 320A have not been folded into the container index 330A. The storage controller 110 then determines whether the first journal 320A is stagnant by comparing one or more journal metrics against corresponding thresholds. For example, the storage controller 110 may read a fill rate metric (e.g., the count of consecutive time periods with in which the amount added to the particular journal is below a low threshold) from the journal metadata 340, and may compare the fill rate metric against a fill rate threshold to determine whether the first journal 320A is stagnant. In another example, the storage controller 110 may read a bandwidth metric (e.g., the cumulative bandwidth used to transfer the journal 320A over a specified number of time periods) from the journal metadata 340, and may compare the bandwidth metric against a bandwidth threshold to determine whether the first journal 320A is stagnant. Upon determining that the journal 320A is stagnant, the storage controller 110 folds the contents of the journal 320A into the associated container index 330A, clears the journal 320A, and then resets the metrics for journal 320A in the journal metadata 340.

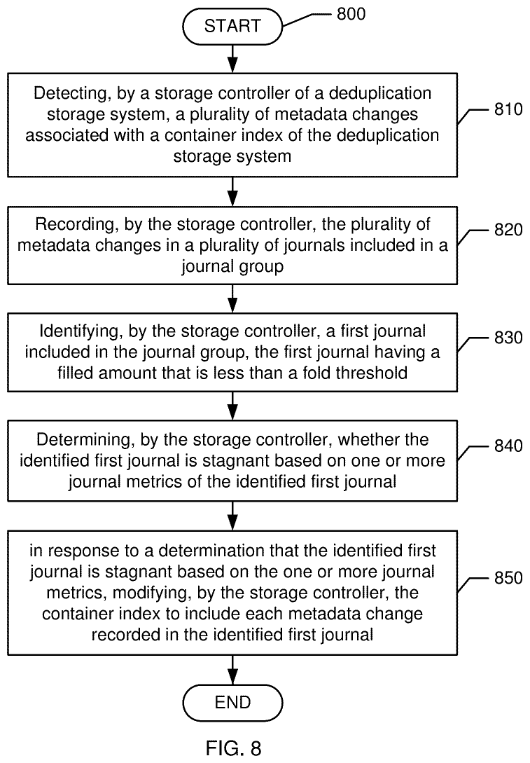

### FIG. 8—Example Process for Clearing Stagnant Journals

FIG. 8 shows an example process 800 for clearing stagnant journals, in accordance with some implementations. In some examples, the process 800 may be performed using the storage controller 110 (shown in FIG. 1A). The process 800 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 810 may include detecting, by a storage controller of a deduplication storage system, a plurality of metadata changes associated with a container index of the deduplication storage system. Block 820 may include recording, by the storage controller, the plurality of metadata changes in a plurality of journals included in a journal group. Block 830 may include identifying, by the storage controller, a first journal included in the journal group, the first journal having a filled amount that is less than a fold threshold.

Block 840 may include determining, by the storage controller, whether the identified first journal is stagnant based on one or more journal metrics of the identified first journal. Block 850 may include, in response to a determination that the identified first journal is stagnant based on the one or more journal metrics, modifying, by the storage controller, the container index to include each metadata change recorded in the identified first journal. Blocks 810-850 may correspond generally to the examples described above with reference to instructions 710-750 (shown in FIG. 7).

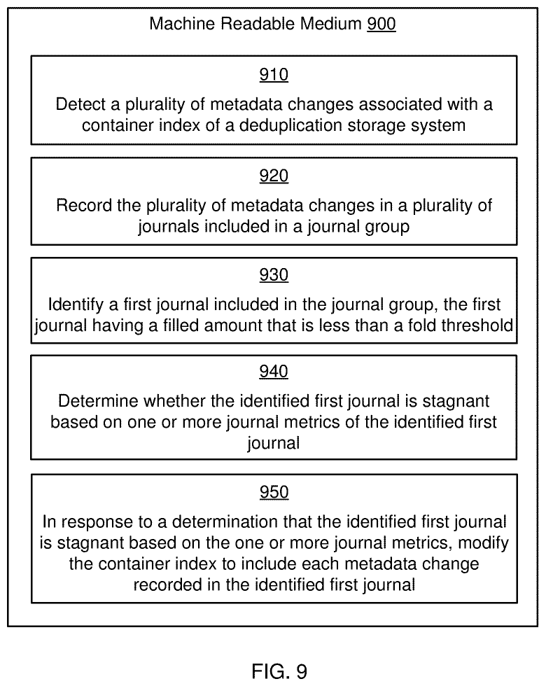

### FIG. 9—Example Machine-Readable Storage Medium

FIG. 9 shows a machine-readable storage medium 900 including instructions 910-950, in accordance with some implementations. The instructions 910-950 can be executed by a single processor, multiple processors, a single processing engine, multiple processing engines, and so forth. The machine-readable medium 900 may be a non-transitory storage medium, such as an optical, semiconductor, or magnetic storage medium. The instructions 910-950 may correspond generally to the examples described above with reference to instructions 710-750.

Instruction 910 may be executed to detect a plurality of metadata changes associated with a container index of a deduplication storage system. Instruction 920 may be executed to record the plurality of metadata changes in a plurality of journals included in a journal group. Instruction 930 may be executed to identify a first journal included in the journal group, the first journal having a filled amount that is less than a fold threshold.

Instruction 940 may be executed to determine whether the identified first journal is stagnant based on one or more journal metrics of the identified first journal. Instruction 950 may be executed to, in response to a determination that the identified first journal is stagnant based on the one or more journal metrics, modify the container index to include each metadata change recorded in the identified first journal.

### Conclusion

In accordance with some implementations of the present disclosure, a controller of a deduplication storage system may generate journal metrics to reflect characteristics of each journal in a journal group. The journal metrics may include a fill rate metric that indicates the increase in filled amount of a journal over time. Further, the journal metrics may include a bandwidth metric that indicates the cumulative bandwidth usage of the journal over time. In some implementations, the controller may analyze the journal metrics to identify any stagnant journals, and may then clear the stagnant journals by folding their contents into one or more container indexes. In this manner, the number of stagnant journals may be reduced, thereby reducing or eliminating the wasted bandwidth associated with transferring the stagnant journals to and from storage. Accordingly, some implementations may improve the performance of the storage system.

Note that, while FIGS. 1A-9 show various examples, implementations are not limited in this regard. For example, referring to FIG. 1A, it is contemplated that the storage system 100 may include additional devices and/or components, fewer components, different components, different arrangements, and so forth. In another example, it is contemplated that the functionality of the storage controller 110 described above may be included in any another engine or software of storage system 100. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A computing device comprising:
at least one processor;
a memory; and
at least one machine-readable storage medium comprising instructions executable by the at least one processor to:
detect a plurality of metadata changes associated with a container index of a deduplication storage system;
record the plurality of metadata changes in a plurality of journals included in a journal group;
identify a first journal included in the journal group, the first journal having a filled amount that is less than a fold threshold;
determine whether the identified first journal is stagnant based on one or more journal metrics of the identified first journal; and
in response to a determination that the identified first journal is stagnant based on the one or more journal metrics, modify the container index to include each metadata change recorded in the identified first journal.

2. The computing device of claim 1, wherein the one or more journal metrics comprise at least one of:
a fill rate metric indicating an increase of the filled amount in the identified first journal over time; and
a bandwidth metric indicating a cumulative bandwidth usage of the identified first journal over time.

3. The computing device of claim 2, including instructions executable by the at least one processor to:
for each time period of a plurality of time periods, determine an amount of data added to the identified first journal during the time period;
determine a number of consecutive time periods in which the amount of data added is below a low threshold; and
in response to a determination that the determined number of consecutive time periods is greater than a fill rate threshold, determine that the identified first journal is stagnant.

4. The computing device of claim 3, including instructions executable by the at least one processor to:
for each time period of the plurality of time periods, determine an amount of bandwidth used to transfer the identified first journal during the time period;
determine a cumulative bandwidth used to transfer the identified first journal during the time period across the plurality of time periods; and
in response to a determination that the determined cumulative bandwidth is greater than a bandwidth threshold, determine that the identified first journal is stagnant.

5. The computing device of claim 4, wherein each time period of the plurality of time periods is defined by a different save of the journal group.

6. The computing device of claim 4, wherein the fold threshold, the low threshold, the fill rate threshold, and the bandwidth threshold are configuration settings of the deduplication storage system.

7. The computing device of claim 4, wherein the bandwidth threshold is dynamically calculated to cause a particular percentage of the plurality of journals to be folded based on the bandwidth metric.

8. The computing device of claim 1, including instructions executable by the at least one processor to, after modifying the container index to include each metadata change recorded in the identified first journal:
delete each metadata change from the identified first journal; and
reset the one or more journal metrics of the identified first journal.

9. The computing device of claim 8, including instructions executable by the at least one processor to:
prior to recording the plurality of metadata changes in the plurality of journals, load the journal group from persistent storage into memory in a single load operation; and
after deleting each metadata change from the identified first journal, write the journal group from the memory into the persistent storage in a single write operation.

10. A method comprising:
detecting, by a storage controller of a deduplication storage system, a plurality of metadata changes associated with a container index of the deduplication storage system;
recording, by the storage controller, the plurality of metadata changes in a plurality of journals included in a journal group;
identifying, by the storage controller, a first journal included in the journal group, the first journal having a filled amount that is less than a fold threshold;
determining, by the storage controller, whether the identified first journal is stagnant based on one or more journal metrics of the identified first journal; and
in response to a determination that the identified first journal is stagnant based on the one or more journal metrics, modifying, by the storage controller, the container index to include each metadata change recorded in the identified first journal.

11. The method of claim 10, wherein the one or more journal metrics comprise at least one of:
a fill rate metric indicating an increase of the filled amount in the identified first journal over time; and
a bandwidth metric indicating a cumulative bandwidth usage of the identified first journal over time.

12. The method of claim 11, comprising:
for each time period of a plurality of time periods, determining an amount of data added to the identified first journal during the time period;
determining a number of consecutive time periods in which the amount of data added is below a low threshold; and
in response to a determination that the determined number of consecutive time periods is greater than a fill rate threshold, determining that the identified first journal is stagnant.

13. The method of claim 12, comprising:
for each time period of the plurality of time periods, determining an amount of bandwidth used to transfer the identified first journal during the time period;
determining a cumulative bandwidth used to transfer the identified first journal during the time period across the plurality of time periods; and
in response to a determination that the determined cumulative bandwidth is greater than a bandwidth threshold, determining that the identified first journal is stagnant.

14. The method of claim 10, comprising, after modifying the container index to include each metadata change recorded in the identified first journal:
deleting each metadata change from the identified first journal; and
resetting the one or more journal metrics of the identified first journal.

15. A non-transitory machine-readable storage medium comprising instructions executable by at least one processor to:
detect a plurality of metadata changes associated with a container index of a deduplication storage system;
record the plurality of metadata changes in a plurality of journals included in a journal group;
identify a first journal included in the journal group, the first journal having a filled amount that is less than a fold threshold;
determine whether the identified first journal is stagnant based on one or more journal metrics of the identified first journal; and
in response to a determination that the identified first journal is stagnant based on the one or more journal metrics, modify the container index to include each metadata change recorded in the identified first journal.

16. The non-transitory machine-readable medium of claim 15, wherein the one or more journal metrics comprise at least one of:
a fill rate metric indicating an increase of the filled amount in the identified first journal over time; and
a bandwidth metric indicating a cumulative bandwidth usage of the identified first journal over time.

17. The non-transitory machine-readable medium of claim 16, including instructions executable by the at least one processor to:
for each time period of a plurality of time periods, determine an amount of data added to the identified first journal during the time period;
determine a number of consecutive time periods in which the amount of data added is below a low threshold; and
in response to a determination that the determined number of consecutive time periods is greater than a fill rate threshold, determine that the identified first journal is stagnant.

18. The non-transitory machine-readable medium of claim 17, including instructions executable by the at least one processor to:
for each time period of the plurality of time periods, determine an amount of bandwidth used to transfer the identified first journal during the time period;
determine a cumulative bandwidth used to transfer the identified first journal during the time period across the plurality of time periods; and
in response to a determination that the determined cumulative bandwidth is greater than a bandwidth threshold, determine that the identified first journal is stagnant.

19. The non-transitory machine-readable medium of claim 15, including instructions executable by the at least one processor to, after modifying the container index to include each metadata change recorded in the identified first journal:
delete each metadata change from the identified first journal; and
reset the one or more journal metrics of the identified first journal.

20. The non-transitory machine-readable medium of claim 19, including instructions executable by the at least one processor to:
prior to recording the plurality of metadata changes in the plurality of journals, load the journal group from persistent storage into memory in a single load operation; and
after deleting each metadata change from the identified first journal, write the journal group from the memory into the persistent storage in a single write operation.
